(19) United States
(12) Patent Application Publication
(10) Pub. No.: US 2011/0043091 A1
(43) Pub. Date: Feb. 24, 2011

(54) Structure of LED Lamps

(76) Inventor: Wei Jung LEE, Taipei City (TW)

Correspondence Address: TROXELL LAW OFFICE, PLLC, P.O. Box 1370, Annandale, VA, 22003, US

(21) Appl. No.: 12/545,836

(22) Filed: Aug. 23, 2009

(51) Int. Cl. H01J 61/52

(52) U.S. Cl. 313/46

(57) ABSTRACT

An improved structure of LED lamps, which tightly fixes the LED to circuit board through indirectly pressing. The improved structure of LED lamps comprises of a lamp shell, the inside of which can be configured with a first circuit board attached with LED, and a second circuit board attached with positive and negative terminals; in particular: on either ends of the lamp shell, a supporting structure and a back cover can be configured. Screws can go through the screw hole(s) which are on the back cover and lock into the support pillar(s) of the supporting structure. Through the screwing, the supporting structure pulls the LED, first circuit board and lamp shell altogether, and provides an indirectly pressure on the first circuit board further makes the first circuit board attach tightly to the platform of lamp shell, accomplishing tight and accurate positioning effect, better heat transfer and heat conduction effect.

### BACKGROUND OF INVENTION

1. Field of the Invention

The present invention relates generally to an improved structure of lamps, and more particularly to an improved structure of LED lamps, which offers excellent heat dissipation and provides better inner structure of the lamps to avoid damage of the circuit boards.

2. Description of Related Art

In a traditional LED lamp, the circuit board is fixed onto the lamp shell by a fastening screw that goes through the circuit board. Such method provides easy and fast installation, but may cause the following problems:

1) When fixing the circuit board onto the lamp shell by using the fastening screw, the pressure on the circuit board may not be balanced due to improper fastening. It would cause: a) when fastening the circuit board too tight, the circuit board may crack due to over-pressure; b) when fastening the circuit board unevenly, certain contact area between the circuit board and lamp shell which are too loose may cause inefficient heat conduction later result in low efficiency of heat dissipation.

2) In the traditional LED lamp, the LED is adhered to the circuit board by soldering. However, in this configuration, repeated thermal expansion and contraction may cause tin crack or fall-off rendering reduced heat conduction efficiency. As the result leading to an increase in temperature inside the LED which causes damage to the LED.

In order to overcome the aforesaid problems which may be caused by the general LED lamp structure the improved LED structure invented by the inventor has significantly solved the problems mentioned above. Moreover, with this improved LED structure, we not only reach a high reliable structure of thermal management but also retain an easy LED lamp assembly structure.

### SUMMARY OF THE INVENTION

The main objective of the present invention is to provide an innovative LED lamp structure which offers excellent heat dissipation and provides better inner structure of the LED lamps to avoid damage of the circuit board.

In order to achieve the above objective, the technique adopted by the present invention is to develop an improved structure of LED lamps. The main configuration of a lamp shell is with a first slot and a second slot which are on the each end of the lamp shell in the direction of an axis, and with perforation(s)¹ and through hole(s) on the platform² which is between a first slot and a second slot. The first slot is configured with the first circuit board which has the LED on it, and the second slot is configured with the second circuit board which has two wires connected to the positive and negative terminal of the first circuit board by going though the through hole(s). ¹There will be at least one perforation on the platform which is between the first and the second slot, and the number/size of the perforation will be different according to the different need.²The platform is part of the lamp shell.

Above the LED is a supporting structure which is used to hold the lens and fix the LED, first circuit board and lamp shell all together. The supporting structure has support pillar(s) which goes through the perforation(s) that can provide a pulling strength by fastening screw(s) which can pull the support pillar(s) against the back cover. Such pulling strength provide an indirect pressure on the first circuit board, therefore, it can make the first circuit board attach tightly with the platform without damaging the circuit board and eventually provide high efficient heat conduction.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows an exploded view of the LED lamp structure in a preferred embodiment of the present invention.

FIG. 2 shows an assembled view of the LED lamp structure in a preferred embodiment of the present invention.

FIG. 3 shows a sectional view of the LED lamp structure in a preferred embodiment of the present invention.

FIG. 4 shows a structural view of another lamp shell and supporting structure of the LED lamp in a preferred embodiment of the present invention.

### DETAILED DESCRIPTION OF THE INVENTION

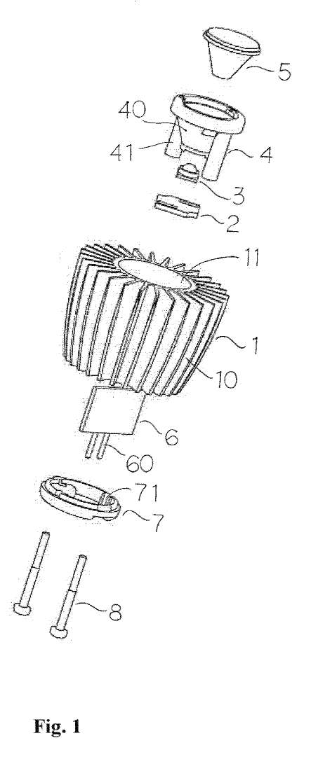

FIG. 1 is an exploded view of the LED lamp structure in a preferred embodiment of the present invention; the LED lamp structure comprises at least:

a lamp shell 1, configured on the peripheral edge with multiple radial fins 10 equally spaced so as to provide good and quick heat convection during usage; moreover, the structure of the lamp shell 1 can be hollow or solid inside. In the case of a hollow structure, it can further comprise: one single slot or multiple slots on the each end of the lamp shell 1 in the direction of axis. The embodiment disclosed herein adopts a shape with configurations of a first slot 11 and a second slot 12 on each end of the lamp shell 1 in the direction of axis and with perforation(s) 13 and through hole(s) 14 on the platform which is between first slot 11 and second slot 12 (cannot be shown in the figure due to angle of view);

a first circuit board 2, which can be a regular circuit board or a circuit board using carbon base metal matrix composite. First circuit board 2 shall be installed inside the first slot 11. The dimensions of the first circuit board 2 shall not affect and block the perforation(s) 13 and through hole(s) 14. On the first circuit board 2, an LED 3 is configured to provide illumination;

a supporting structure 4, embedded in the first slot 11, to hold the lens 5 and fix the LED 3, first circuit board 2 and lamp shell 1 all together. Further, its structure comprises a cone-shaped concave part 40 with both ends open and two support pillars 41 that extend downward from its edge. The optical lens 5 is embedded within the larger open end of the cone-shape concave part 40, and the upper side of LED 3 is completely covered by the smaller open end of the cone-shape concave part 40. The supporting structure 4 has two support pillars 41 which go through the perforations 13 for positioning and can provide a pulling strength by fastening screws which can pull the two support pillars against the back cover 7. Such pulling strength provides an indirect pressure on the first circuit board 2, therefore, it can make the first circuit board 2 attach tightly with the platform without damaging the circuit board 2 and eventually provide high efficient heat conduction;

a second circuit board 6, which can be a regular circuit board or a circuit board using carbon base metal matrix composite. Second circuit board 6 shall be installed inside the second slot 12 It has two wires which connect with the positive and negative terminal of the first circuit board 2 by going though the through holes 14. The second circuit board 6 is configured with positive and negative terminals 60 for conductance;

a back cover 7, covering and sealing the opening of the second slot 12 of the lamp shell 1. It is configured with two screw holes 70 corresponding to the perforations 13 (cannot be shown in the figure due to angle of view); and a set of sockets 71 which can fix the second circuit board 6 and a set of positioning holes 72 for inserting the positive and negative terminals 60 (cannot be shown in the figure due to angle of view); two screws 8, which respectively go through the screw holes 70 on the back-cover 7, and lock into the two support pillars 41 of the 1 supporting structure 4. If the end of the two support pillars 41 are designed in the structure of a tenon, the screws 8 would not be necessary anymore, and the support pillars 41 can directly go through and lock into the screw holes 70 on the back cover 7.

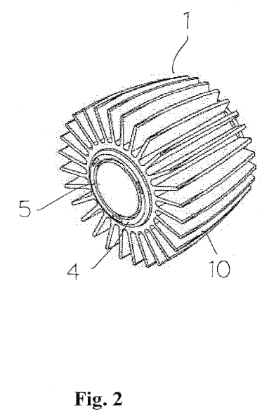

FIG. 2 is an assembled perspective view of the LED lamp structure in a preferred embodiment of the present invention; the process of assembly of the above components is as follow:

First, soldering the LED 3 on the first circuit board 2, placing the supporting structure 4 on the LED 3, and the upper side of LED 3 is completely covered by the smaller open end of the cone-shape concave part 40. Inserting the supporting structure 4 along with LED 3 and first circuit board 2 into the first slot 11 by making the two support pillars go through the two perforations 13 which are on the platform.

Second, inserting the second circuit board 6 into the second slot, connecting the positive and negative terminal of the first circuit board 2 by making the wires which are on the second circuit board 6 go though the two through holes 14.

Third, sealing the second slot by back cover 7, making the positive and negative terminal which is fixed with the second circuit board 6 go though the two positioning holes 72.

Finally, fastening the two crews 8 through the screw holes 70 and corresponding to the two support pillars 41.

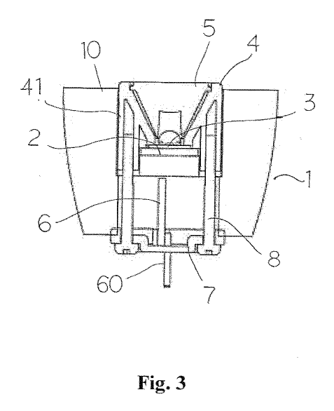

FIG. 3 is an overall sectional view of the LED lamp structure in a preferred embodiment of the present invention; In actual implementation of the whole lamp structure as composed above, the lamp is installed in a lamp fixture and provides illumination once it is connected with electric power; during usage, continuous illumination will cause the LED 3 to generate heat; as the first circuit board 2 attaches tightly with the platform of the lamp shell 1, due to the pulling strength which is caused by fastening the screw(s) through the support pillar(s) 41, the heat, therefore, can be efficiently transferred. Moreover, with the equally spaced multiple radial fins 10 configured on the peripheral edge of the lamp shell 1, the heat convection can be fast and efficient.

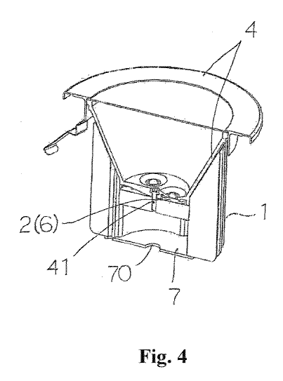

FIG. 4 is a structural view of another lamp shell and supporting structure of the LED lamp which is with one support pillar only in a preferred embodiment of the present invention; As mention in footnote 1, in order to simplify the lamp structure and reduce cost, the support pillar here in the FIG. 4 reduce to one pillar only. But the rest configurations remain the same, i.e. the support pillar 41 extends from the supporting structure 4 for binding the supporting structure 4, platform of the lamp shell and circuit board. The circuit board here integrates the original first circuit board 2 and second circuit board 6. In this case, in assembly of the lamp, the circuit board 2, 6 in the lamp shell 1 can still be quickly, tightly and accurately positioned on the supporting structure.

According to the above descriptions, in the improved structure of LED lamps designed by the present invention, the circuit board is fixed mainly through a three-layer locking and positioning method: a supporting structure and back cover in the lamp shell are tightly combined (by screwing through the back cover to the support pillar(s)), which can provide a pulling strength to make the first circuit board fix/attach tightly to the platform of the lamp shell. With the three-layer locking and positioning method, the circuit board can tightly attach/fix to the lamp shell without being damaged due to any direct pressure on it (in the prior art, usually, the circuit board is fixed by screwing, which would make direct pressure on it and cause tin crack or fall-of problem later reduce the efficiency of heat conduction). The three-layer locking and positioning method provides a pulling strength which makes the circuit board tightly fix/attach to the lamp shell with an indirect pressure on the circuit board, and reach an efficient hear conduction. Hence, the present invention is indeed an excellent innovation that has a value to be industrially utilized.

To sum up, the present invention has really made a breakthrough in efficacy, and investigations into related documents have not found any similar inventions disclosed or similar products in the market, it perfectly meets the requirements of patent application for novelty, advancement and practicability. Therefore, a patent application is formally proposed in accordance with related laws.

Although the invention has been explained in relation to its preferred embodiment, it is to be understood that many other possible modifications and variations can be made without departing from the spirit and scope of the invention as hereinafter claimed.

1. An improved structure of LED lamps, which comprises a lamp shell, configured inside with a first circuit board attached with a LED, and a second circuit board attached with positive and negative terminals; the said first and second circuit boards are electrically connected via wires, and one end of the said lamp shell is covered and sealed by a back cover; its characteristics are as follow:
a supporting structure is configured on the other end of the said lamp shell; with at least one support pillar, it is fixed and combined with the back cover by screwing through the screw holes of back cover to the support pillar(s) which would provides a pulling strength, the LED on the first said circuit board is contacted for tight positioning, without causing any damage to the said first circuit board and contributing to efficient heat conduction.

2. The improved structure of LED lamps as claimed in claim 1, wherein the two ends in the direction of axis of the said lamp shell can be configured with first slot and second slot, and between the first and second slot is a platform with perforation(s) and through-hole(s) on it.

3. The improved structure of LED lamps as claimed in claim 1, wherein the said lamp shell and supporting structure can be integrally formed.
